(19) United States
(12) Patent Application Publication
(10) Pub. No.: US 2010/0044645 A1
(43) Pub. Date: Feb. 25, 2010

(54) METHOD FOR PRODUCING CONDUCTIVE POLYURETHANE MOLDED BODY AND CONDUCTIVE ROLL

(75) Inventors: Naoyuki Ohmori, Kanagawa (JP); Suguru Yamada, Kanagawa (JP)

Correspondence Address: K&L Gates LLP, P.O. Box 1135, CHICAGO, IL, 60690, US

(73) Assignee: NIPPON POLYURETHANE INDUSTRY CO., LTD., Tokyo (JP)

(21) Appl. No.: 12/524,115

(22) PCT Filed: Jan. 16, 2008
(86) PCT No.: PCT/JP2008/000032

§ 371 Date: Sep. 29, 2009

(30) Foreign Application Priority Data
Jan. 24, 2007 (JP) 2007-013392

(51) Int. Cl. H01B 1/20

(52) U.S. Cl. 252/500

(57) ABSTRACT

The present invention provides a method for producing a conductive polyurethane molded body that can reconcile a satisfactory conductivity with a satisfactory moldability or, in place of this, can provide a high conductivity while securing a suitable moldability, and provides a conductive roll. A conductive polyurethane molded body is obtained by employing as main starting materials polyol and isocyanate that contains at least 60 mass % of 2,4′-diphenylmethane diisocyanate, incorporating thereinto at least a conductivity-imparting agent, and reacting and molding. The conductive polyurethane foam obtained when this reaction is carried out with the addition of a foaming agent is well suited for use as a conductive roll.

### TECHNICAL FIELD

The present invention relates to a method for producing a conductive polyurethane molded body and to a conductive roll.

### BACKGROUND ART

The roll members used in, for example, office automation equipments such as facsimile machines and copiers, are used for applications such as the electrical adsorption and transport of toner. Due to this, a suitable level of electrical conductivity is required of such a roll member. In addition, the roll member must have a low hardness that avoids damage to any other members engaged in contact therewith.

A polyurethane molded body obtained by the reaction of isocyanate and polyol (conductive polyurethane molded bodies) are widely used as the material of such roll members (referred to herebelow as conductive rolls).

Tolylene diisocyanate (TDI) may be used as the isocyanate in this case.

However, TDI provides a low productivity due to its low reactivity. In addition, TDI exhibits a high vapor pressure in the temperature region in which molding is performed, and as a result at high temperatures the process becomes problematic from a safety and hygiene perspective and is thus reserved for specified chemical substances.

In order to avoid these issues, various methods have been introduced that use diphenylmethane diisocyanate (MDI) instead of TDI as the isocyanate.

In these cases, an MDI is frequently used in which the main component is 4,4′-MDI, which is one of the several possible isomers (structural isomers).

However, conductive rolls obtained using MDI in which the main component is 4,4′-MDI do not necessarily have a sufficiently low hardness. Another problem with conductive rolls of this type is that they are unable to satisfactorily respond to the increasing demand for even lower hardnesses that is being brought on by the development of electronic equipment. It has also been reported that the higher viscosity due to the use of MDI in place of TDI has effects on the moldability.

In order to improve upon these problems, a method has been introduced that uses a mixture of MDI isomers as the isocyanate.

For example, with the goal of lowering the viscosity, a method has been introduced for producing a conductive elastic member for electrophotographic applications (conductive elastic electrophotographic member); this method uses a mixture of MDI isomers as the isocyanate (refer to Patent Document 1). In specific terms, the use of a mixture of 50 mol % to 80 mol % 4,4′-MDI and 20 mol % to 50 mol % 2,4′-MDI is preferred. A satisfactory lowering of the viscosity is not obtained at less than 20 mol % 2,4′-MDI, while the use of more than 50 mol % 2,4′-MDI can result in a lowering of the mechanical properties and the generation of surface tack (stickiness).

A low hardness is shown for the conductive elastic electrophotographic member obtained by this method when 1 mass part Ketjenblack (conductive carbon) is blended into 100 mass parts of the starting polyol, but the conductivity level is not identified.

Taking a different perspective from Patent Document 1, in order to obtain polyurethane slab foam that exhibits a soft surface sensation, supportability, durability, and a broad range of hardnesses and densities (refer to Patent Document 2), a method has been introduced that uses MDI containing 5 mass % to 30 mass % 2,4′-MDI for a portion of the isocyanate as one blending parameter for a specific isocyanate and polyol.

However, in this case no parameters are shown for the incorporation of Ketjenblack (conductive carbon) in the obtained polyurethane slab foam. Due to this, with respect to the use of 2,4′-MDI as a portion of the isocyanate, there is no disclosure whatever of the influence of the quantity of Ketjenblack addition on the characteristics of the polyurethane slab foam, i.e., there is no disclosure whatever of the relationship between 2,4′-MDI and the quantity of Ketjenblack addition; however, it can be presumed that the obtained polyurethane slab foam does not necessarily have a high conductivity.

In order to improve upon the problems with the processing environment that arise due to the use of TDI and to bring about additional improvements in the properties of the polyurethane foam, a method has been introduced in which MDI is used as the isocyanate and in combination therewith the total amount of 2,4′-MDI and 2,2′-MDI, which are isomers other than 4,4′-MDI, is set at 10 mass % to 50 mass % of the total MDI (Patent Document 3).

However, in this case also it can be presumed that the obtained polyurethane foam does not necessarily have a high conductivity due to the specification of the incorporation of 3 mass % to 6 mass % acetylene black (conductive carbon) with reference to the polyol.
[Patent Document 1] Japanese Unexamined Publication No. 2001-51525
[Patent Document 2] Japanese Unexamined Publication No. 2001-2749
[Patent Document 3] Japanese Unexamined Publication No. 2004-292718

### DISCLOSURE OF THE INVENTION

### Problems to be Solved by the Invention

None of the technologies in Patent Documents 1 to 3, each of which employs a mixture of MDI isomers for the isocyanate, have the direct object of providing an additional improvement in conductivity, nor do they necessarily provide a good conductivity for the obtained conductive elastic electrophotographic member. In addition, for all of these technologies, for example, the incorporation of large amounts of conductive carbon in order to secure the conductivity would presumably produce the problem of a reduced moldability.

The present invention was pursued in view of the previously described problems and takes as an object the introduction of a method for producing a conductive polyurethane molded body that can reconcile a satisfactory conductivity with a satisfactory moldability or, in place of this, can provide a high conductivity while securing a suitable moldability. A further object of the present invention is to provide a conductive roll.

### Means for Solving the Problem

The method for producing a conductive polyurethane molded body according to the present invention comprises employing as main starting materials polyol and isocyanate that contains at least 60 mass % of 2,4′-diphenylmethane diisocyanate, incorporating thereinto at least a conductivity-imparting agent, and reacting and molding.

The method for producing a conductive polyurethane molded body according to the present invention also preferably comprises carrying out the reaction with the further addition of a foaming agent.

The method for producing a conductive polyurethane molded body according to the present invention also preferably uses water as the foaming agent.

The conductive roll according to the present invention uses the conductive polyurethane molded body obtained according to a production method as described above.

### EFFECTS OF THE INVENTION

The method for producing a conductive polyurethane molded body according to the present invention—because it comprises employing as the main starting materials polyol and isocyanate that contains at least 60 mass % of 2,4′-diphenylmethane diisocyanate, incorporating thereinto at least a conductivity-imparting agent, and reacting and molding—can reconcile a satisfactory conductivity with a satisfactory moldability or, in place of this, can provide a high conductivity while securing a suitable moldability.

The conductive roll according to the present invention, because it uses a conductive polyurethane molded body obtained by the previously described method, is particularly well suited for providing the effects of the aforementioned conductive polyurethane molded body.

### BEST MODES FOR CARRYING OUT THE INVENTION

Preferred embodiments are detailed below for the method for producing a conductive polyurethane molded body according to the present invention and for the conductive roll according to the present invention.

The method for providing a conductive polyurethane molded body according to this embodiment comprises employing as the main starting materials polyol and isocyanate that contains at least 60 mass % of 2,4′-diphenylmethane diisocyanate (hereinafter referred to as 2,4′-MDI), incorporating thereinto at least a conductivity-imparting agent, and reacting and molding.

With regard to the isocyanate encompassed by the main starting materials as described above (the isocyanate component), there are no particular limitations on the remaining, other than 2,4′-MDI isocyanate component. Thus, for example, the 4,4′-MDI isomer is preferably used as the remaining isocyanate component, but the present invention is not limited to this, and, as long as the objects of the present invention are achieved, for example, polyphenylenepolymethylene polyisocyanate may be used or a suitable quantity of tolylene diisocyanate may be used or a suitable quantity of other types of polyisocyanate may be used. A suitable quantity of a modified isocyanate or a prepolymer may also be used as the remaining isocyanate component.

The 2,4′-MDI content in this isocyanate is at least 60 mass % and larger content are more preferable. However, when the unavoidable admixture of, for example, the 2,2′-MDI isomer is taken into account, the upper limit is about 99.9 mass %. The 2,2′-MDI is desirably removed to the greatest extent possible, and, for example, no more than about 0.5 mass % is more preferred from the perspective of obtaining molded bodies that exhibit a good moldability.

There are no particular limitations on the polyol encompassed by the aforementioned main starting materials, and, for example, a suitable selection from the various types of polyether-type polyols or polyester-type polyols can be used.

In addition to the previously described main starting materials, at least a conductivity-imparting agent is incorporated in the method for producing a conductive polyurethane molded body according to this embodiment, as an auxiliary material in order to impart conductivity to the resulting molded body.

The quantity of incorporation of the conductivity-imparting agent used is to be the quantity necessary to impart the desired conductivity to the molded body. As an example, in order to secure the same level of conductivity as in the prior art examples, in which examples the content of 2,4′-MDI in the isocyanate component was, for example, no greater than 50 mass %, the content of the conductivity-imparting agent can be reduced from that in the prior art examples, which results in a reduction in the reaction viscosity during molded body production and thereby enables molded bodies that exhibit an excellent moldability to be obtained. In addition, a conductivity higher than in the prior art examples can be imparted to the molded body by increasing the content of the conductivity-imparting agent in a range in which viscosity increase-induced effects on the moldability are not produced.

There are no particular limitations on the conductivity-imparting agent that is incorporated and, for example, conductive carbons, ionic conductors, and so forth can be used. These materials may be used in combination.

Usable as the conductive carbon are Ketjenblack (high-conductivity carbon black), acetylene black, or other carbon blacks, wherein Ketjenblack is more preferred thereamong when the contribution to the conductivity is taken into account. When Ketjenblack is used, a Ketjenblack having a BET specific surface area of at least 200 m²/g and more preferably at least 600 m²/g is preferred.

While the use of Ketjenblack (high-conductivity carbon black) for the conductive carbon is preferred, the present invention is not limited to this and acetylene black and other carbon blacks can be used.

Preferred for use as the ionic conductor are lithium imides and particularly the potassium bis(trifluoromethanesulfonyl)imide or lithium bis(trifluoromethanesulfonyl)imide proposed by the present applicant. On the subject of other additives, metal oxides can also be used as a filler.

Auxiliary materials other than the conductivity-imparting agent can be suitably incorporated as necessary in the method for producing a conductive polyurethane molded body according to this embodiment.

When the conductive polyurethane molded body is to be obtained in the form of a conductive polyurethane foam, the reaction is carried out with the addition of a foaming agent as an auxiliary material. There are no particular limitations in this case on the foaming agent, and the various types of physical foaming agents or chemical foaming agents can be used. However, foaming with water or mechanical frothing (introduction of a gas into the liquid reaction system by mechanical stirring during the reaction step) are preferred from an environmental standpoint.

Suitable auxiliary materials, e.g., catalysts, foam regulators, chain elongation agents, crosslinking agents, flame retardants, stabilizers, and so forth, can also be incorporated in suitable quantities in correspondence to the productivity and properties required of the conductive polyurethane molded body.

Nor are there any particular limitations on the applications of the conductive polyurethane molded bodies obtained using the method according to this embodiment of obtaining a conductive polyurethane molded body. In the case of the foam products, the conductive polyurethane molded bodies are well suited for application as conductive rolls, and conductive rolls can be obtained that exhibit an excellent balance between conductivity and moldability or that exhibit a high conductivity while maintaining their moldability.

The conductive rolls under consideration can be used as, for example, the toner transport rolls, charging rolls, developing rolls, transfer rolls, cleaning rolls, and so forth, that are employed in electrophotographic devices.

### Examples

The present invention will be explained in additional detail by providing Examples of the production of conductive polyurethane foams. The present invention is not limited to the Examples provided in the following.

(Synthesis of Isocyanate-Terminated Prepolymers)

The isocyanate component was charged to a 100 L-reactor equipped with a stirrer, condenser, nitrogen inlet tube, and thermometer and was reacted for 4 hours at a temperature of 80° C. while stirring to obtain an isocyanate-terminated prepolymer.

Prepolymer 1 was obtained according to this sequence by blending 21.25 parts MDI containing at least 99 mass % 2,4′-MDI, 6.20 parts FA-103 (nominal number of functional groups=3, number-average molecular weight=3,400, EO (ethylene oxide) content=70%, from Sanyo Chemical Industries, Ltd.), 9.59 parts GL-600 (nominal number of functional groups=3, number-average molecular weight=600, EO content=20%, from Sanyo Chemical Industries, Ltd.), and 5.75 parts PL-2 100 (nominal number of functional groups=2, number-average molecular weight=2000, EO content=10%, from Sanyo Chemical Industries, Ltd.). Prepolymer 2 was obtained by blending using the same parameters as for prepolymer 1, but among the blending parameters for prepolymer 1 incorporating 21.25 parts MDI that contained at least 99 mass % 4,4′-MDI; prepolymer 3 was obtained by blending using the same parameters as for prepolymer 1, but among the blending parameters for prepolymer 1, incorporating 3.07 parts FA-103 and 3.07 parts GL-3000 (nominal number of functional groups=3, number-average molecular weight=3000, EO content=20%, from Sanyo Chemical Industries, Ltd.) rather than 6.20 parts FA-103; and prepolymer 4 was obtained by blending using the same parameters as for prepolymer 2, but among the blending parameters for prepolymer 2, incorporating 3.07 parts FA-103 and 3.07 parts GL-3000 rather than 6.20 parts FA-103.

(Preparation of the Polyol Premix)

A polyol premix was obtained by charging the following to a container and mixing by stirring: 100 parts GL-3000, 2.0 parts TELA (triethanolamine), 0.3 part water, 0.63 part L-5309 (silicone foam regulator, from GE Toshiba Silicone), 1.26 parts NC-IM (KAOLIZER No. 120, from Kao Corporation), and 0.31 parts catalyst (ToyocatT-ET, from Tosoh Corporation).

(Production of the Conductive Polyurethane Foams)

A conductivity-imparting agent was stirred and mixed into the prepolymer (any ones of prepolymers 1 to 4) and the aforementioned polyol premix after which the liquid mixture was cast into a mold to give a sheet-form conductive polyurethane foam. The conductivity-imparting agent was selected from a lithium imide (Sankonol NEF268-20R from Sanko Chemical Industry Co., Ltd.) and the following three carbon blacks: Ketjenblack (Carbon ECP from Lion Corporation), VXC-72R (from Cabot Japan Co., Ltd.), and acetylene black (Denkablack from Denki Kagaku Kogyo Co., Ltd.).

The resulting sheet-form conductive polyurethane foam was subjected to the following property measurements and evaluation.

Volume resistivity (volume intrinsic resistance value): measured based on JIS K 6911 at an applied voltage of 250 V using an R8340 meter from Advantest Corporation. The measurement atmosphere was 23° C./55RH.

Density: according to JIS K 6401.

Hardness (Asker hardness): measured using an Asker type C hardness tester.

Rebound resilience: measured according to JIS K 7312.

Appearance (foam appearance): the appearance was evaluated visually. A score of “poor” was rendered when cratering (rough skin) was produced, while a score of “good” was rendered when cratering was not present.

The blending parameters for the starting materials and the results for the various properties are shown in Tables 1 to 6 for Examples of the present invention and Comparative Examples. The “parts” unit in Tables 1 to 6 is mass parts in all instances. The quantity of addition for the conductivity-imparting agent is the proportion with respect to the total amount of the organic polyisocyanate and polyol premix.

TABLE 1

| | Examples | | | | | |
|---|---|---|---|---|---|---|
| organic polyisocyanate (parts) | | | | | | |
| prepolymer 1 | 100 | 80 | 60 | — | — | — |
| prepolymer 2 | — | 20 | 40 | — | — | — |
| prepolymer 3 | — | — | — | 100 | 80 | 60 |
| prepolymer 4 | — | — | — | — | 20 | 40 |
| polyol premix (parts) | 154 | 154 | 154 | 154 | 154 | 154 |
| conductivity-imparting agent (%) | | | | | | |
| Ketjenblack | 1 | 1 | 1 | 1 | 1 | 1 |
| VXC-72R | — | — | — | — | — | — |
| acetylene black | — | — | — | — | — | — |
| lithium imide | — | — | — | — | — | — |
| volume resistivity (×10⁸ Ω · cm) | 0.487 | 1.24 | 8.97 | 0.283 | 2.02 | 6.35 |
| density (g/cm³) | 0.53 | 0.51 | 0.5 | 0.5 | 0.49 | 0.5 |
| Asker C hardness (°) | 34 | 33 | 30 | 32 | 32 | 31 |
| rebound resilience (%) | 57 | 46 | 47 | 49 | 49 | 49 |
| foam appearance | good | good | good | good | good | good |

TABLE 2

| | Examples | | | | | |
|---|---|---|---|---|---|---|
| organic polyisocyanate (parts) | | | | | | |
| prepolymer 1 | 100 | 80 | 60 | 100 | 80 | 60 |
| prepolymer 2 | — | 20 | 40 | — | 20 | 40 |
| prepolymer 3 | — | — | — | — | — | — |
| prepolymer 4 | — | — | — | — | — | — |
| polyol premix (parts) | 154 | 154 | 154 | 154 | 154 | 154 |
| conductivity-imparting agent (%) | | | | | | |
| Ketjenblack | — | — | — | — | — | — |
| VXC-72R | 1 | 1 | 1 | — | — | — |
| acetylene black | — | — | — | 1 | 1 | 1 |
| lithium imide | — | — | — | 0.6 | 0.6 | 0.6 |
| volume resistivity (×10⁸ Ωcm) | 8.11 | 50.8 | 453 | 0.0815 | 0.166 | 0.243 |
| density (g/cm³) | 0.55 | 0.54 | 0.55 | 0.52 | 0.52 | 0.51 |
| Asker C hardness (°) | 31 | 40 | 41 | 43 | 37 | 37 |
| rebound resilience (%) | 49 | 56 | 51 | 51 | 54 | 51 |
| foam appearance | good | good | good | good | good | good |

TABLE 3

| | Examples | | | | | | | |
|---|---|---|---|---|---|---|---|---|
| organic polyisocyanate (parts) | | | | | | | | |
| prepolymer 1 | 100 | 80 | 60 | 100 | 100 | 100 | 80 | 60 |
| prepolymer 2 | — | 20 | 40 | — | — | — | 20 | 40 |
| prepolymer 3 | — | — | — | — | — | — | — | — |
| prepolymer 4 | — | — | — | — | — | — | — | — |
| polyol premix (parts) | 154 | 154 | 154 | 154 | 154 | 154 | 154 | 154 |
| conductivity-imparting agent (%) | | | | | | | | |
| Ketjenblack | — | — | — | 1 | 1 | — | — | — |
| VXC-72R | — | — | — | — | — | — | — | — |
| acetylene black | — | — | — | — | — | — | — | — |
| lithium imide | 0.6 | 0.6 | 0.6 | 0.3 | 0.6 | 0.3 | 0.3 | 0.3 |
| volume resistivity (×10⁸ Ωcm) | 0.54 | 0.552 | 0.614 | 0.359 | 0.306 | 1.04 | 1.09 | 0.445 |
| density (g/cm³) | 0.51 | 0.53 | 0.53 | 0.54 | 0.54 | 0.53 | 0.54 | 0.53 |
| Asker C hardness (°) | 36 | 36 | 42 | 42 | 41 | 40 | 39 | 41 |
| rebound resilience (%) | 56 | 54 | 50 | 57 | 56 | 56 | 55 | 52 |
| foam appearance | good | good | good | good | good | good | good | good |

TABLE 4

| | Comparative Examples | | | | | |
|---|---|---|---|---|---|---|
| organic polyisocyanate (parts) | | | | | | |
| prepolymer 1 | 100 | 20 | 40 | — | — | — |
| prepolymer 2 | — | 80 | 60 | — | — | — |
| prepolymer 3 | — | — | — | — | 20 | 40 |
| prepolymer 4 | — | — | — | 100 | 80 | 60 |
| polyol premix (parts) | 154 | 154 | 154 | 154 | 154 | 154 |
| conductivity-imparting agent (%) | | | | | | |
| Ketjenblack | 1 | 1 | 1 | 1 | 1 | 1 |
| VXC-72R | — | — | — | — | — | — |
| acetylene black | — | — | — | — | — | — |
| lithium imide | — | — | — | — | — | — |
| volume resistivity (×10⁸ Ωcm) | 65.3 | 249 | 98 | 18 | 43.8 | 44.8 |
| density (g/cm³) | 0.49 | 0.49 | 0.51 | 0.46 | 0.49 | 0.49 |
| Asker C hardness (°) | 37 | 34 | 31 | 37 | 30 | 29 |
| rebound resilience (%) | 61 | 51 | 45 | 57 | 49 | 51 |
| foam appearance | good | good | good | good | good | good |

TABLE 5

| | Comparative Examples | | | | | |
|---|---|---|---|---|---|---|
| organic polyisocyanate (parts) | | | | | | |
| prepolymer 1 | — | 40 | 20 | — | 40 | 20 |
| prepolymer 2 | 100 | 60 | 80 | 100 | 60 | 80 |
| prepolymer 3 | — | — | — | — | — | — |
| prepolymer 4 | — | — | — | — | — | — |
| polyol premix (parts) | 154 | 154 | 154 | 154 | 154 | 154 |
| conductivity-imparting agent (%) | | | | | | |
| Ketjenblack | 2.5 | — | — | — | — | — |
| VXC-72R | — | 1 | 1 | 1 | — | — |
| acetylene black | — | — | — | — | 1 | 1 |
| lithium imide | — | — | — | — | 0.6 | 0.6 |
| volume resistivity (×10⁸ Ω · cm) | 29.4 | 383 | 720 | 934 | 0.566 | 0.803 |
| density (g/cm³) | 0.51 | 0.53 | 0.52 | 0.53 | 0.51 | 0.49 |
| Asker C hardness (°) | 39 | 41 | 40 | 40 | 36 | 36 |
| rebound resilience (%) | 60 | 47 | 50 | 49 | 45 | 56 |
| foam appearance | poor | good | good | good | good | good |

TABLE 6

| | Comparative Examples | | | |
|---|---|---|---|---|
| organic polyisocyanate (parts) | | | | |
| prepolymer 1 | — | 40 | 20 | — |
| prepolymer 2 | 100 | 60 | 80 | 100 |
| prepolymer 3 | — | — | — | — |
| prepolymer 4 | — | — | — | — |
| polyol premix (parts) | 154 | 154 | 154 | 154 |
| conductivity-imparting agent (%) | | | | |
| Ketjenblack | — | — | — | — |
| VXC-72R | — | — | — | — |
| acetylene black | 1 | — | — | — |
| lithium imide | 0.6 | 0.6 | 0.6 | 0.6 |
| volume resistivity (×10⁸ Ω · cm) | 1.72 | 0.693 | 0.703 | 1.12 |
| density (g/cm³) | 0.5 | 0.53 | 0.51 | 0.53 |
| Asker C hardness (°) | 40 | 42 | 43 | 43 |
| rebound resilience (%) | 59 | 59 | 55 | 57 |
| foam appearance | good | good | good | good |

1. A method for producing a conductive polyurethane molded body, the method comprising:
employing as main starting materials polyol and isocyanate that contains at least 60 mass % of 2,4′-diphenylmethane diisocyanate, incorporating thereinto at least a conductivity-imparting agent, and reacting and molding.

2. The method for producing a conductive polyurethane molded body according to claim 1, wherein the reaction is carried out with the further addition of a foaming agent.

3. The method for producing a conductive polyurethane molded body according to claim 2, wherein the foaming agent is water.

4. A conductive roll for which the conductive polyurethane molded body obtained by the method of production according to claim 1 is used.
